(19) United States
(12) Patent Application Publication
(10) Pub. No.: US 2026/0226873 A1
(43) Pub. Date: Aug. 6, 2026

(54) AERONAUTICAL PROPULSION SYSTEM HAVING A DUCTED FAN AND A HIGH BYPASS RATIO

(71) Applicant: SAFRAN AIRCRAFT ENGINES, Paris (FR)

(72) Inventor: Corinne Françoise Michelle THIEBAULT, MOISSY-CRAMAYEL (FR)

(73) Assignee: SAFRAN AIRCRAFT ENGINES, Paris (FR)

(21) Appl. No.: 19/157,428

(22) PCT Filed: Mar. 6, 2024
(86) PCT No.: PCT/FR2024/050272

§ 371 Date: Aug. 18, 2025

(30) Foreign Application Priority Data
Mar. 7, 2023 (FR) FR 2302081

(51) Int. Cl. F02K 3/06; B64D 27/18; F02C 7/36

(52) U.S. Cl. CPC F02K 3/06; B64D 27/18; F02C 7/36; F05D 2220/323

(57) ABSTRACT

An aeronautical propulsion system includes a ducted fan section including a fan, the fan having a fan rotor including blades, and a gas generator including a drive shaft that rotationally drives, directly or indirectly, the fan rotor. The aeronautical propulsion system is dimensioned such as to verify two relationships governing a diameter of the fan rotor, a maximum thrust generated by the fan, and a bypass ratio of a flow through the aeronautical propulsion system.

### TECHNICAL FIELD

This disclosure generally relates to the field of propulsion systems, and more specifically aeronautical propulsion systems have a ducted fan section and a high or very high bypass ratio.

### PRIOR ART

An aeronautical propulsion system generally includes, from upstream to downstream in the direction of flow of the gas, a fan section, a compressor section that may comprise a low-pressure compressor and a high-pressure compressor, a combustion chamber and a turbine section that may comprise a high-pressure turbine and a low-pressure turbine.

When the propulsion system is in operation, the high-pressure compressor is rotationally driven by the high-pressure turbine by way of a high-pressure shaft. The fan and where applicable the low-pressure compressor are rotationally driven by the low-pressure turbine by way of a low-pressure shaft.

One of the objectives of technological research is to improve the environmental performance of aircraft. This is why, in all the design and development phases, the relevant factors are taken into account to obtain aeronautical components and substances that consume less energy, are more environmentally friendly, and whose integration and use in civil aviation have moderate environmental impacts, with the aim of improving the energy efficiency of aircraft.

For example, to improve the propulsive efficiency of an aeronautical propulsion system and to reduce its specific fuel consumption, it has been found that it is advantageous to increase the rotation speed of the low-pressure turbine and of the low-pressure compressor, and to reduce the rotation speed of the fan.

Similarly, to limit the drag and mass of the aircraft, and thus reduce its fuel consumption, it has been found that it is advantageous to make propulsion systems more compact, i.e. to reduce the bulk of all or part of their components.

However, in doing so, it appears that the rotary components of aircraft propulsion systems, particularly those present within the compressor section and the turbine section, are subject to increased centrifugal forces, while having smaller dimensions, which is liable to complicate the design of the propulsion systems to avoid altering their mechanical resistance and/or limiting their life.

### SUMMARY

One aim of the following disclosure is to reduce the fuel consumption of an aircraft propulsion systems without however limiting the life of its rotary components.

This aim is achieved owing to an aircraft propulsion system, comprising:
a ducted fan section comprising a fan, the fan having a fan rotor comprising blades,
a gas generator comprising a drive shaft configured to rotationally drive, directly or indirectly, the fan rotor,
wherein the propulsion system is dimensioned such as to verify the following pair of relationships:

$$a . 0 \leq P \cdot D \cdot {10}^{- 4} \leq 160 and$$

$$b . 2.7 \cdot {( P \cdot D \cdot {10}^{- 4} )}^{0.6} \leq \frac{100 \cdot {D}^{2}}{B P R + 1} \leq 3.9 \cdot {( P \cdot D \cdot {10}^{- 4} )}^{0.6}$$

where D is a diameter of the fan rotor in meters which is measured in a plane normal to an axis of rotation of the fan rotor, at an intersection between an end edge and a leading edge of the blades of the fan rotor;
P is a maximum thrust generated by the fan in Newtons when the propulsion system is static in takeoff rating, in a standard atmosphere and at sea level;
and BPR is a bypass ratio of the stream crossing the propulsion system, defined as a ratio between a mass flow rate of a secondary air stream flowing through the propulsion system around the gas generator, and of a primary air stream flowing through the gas generator, measured when the propulsion system is static, uninstalled, in a rating corresponding to a takeoff of an aircraft comprising the aeronautical propulsion system, in a standard atmosphere and at sea level.

According to an embodiment, the bypass ratio is between 10 and 20 inclusive.

According to an embodiment, the gas generator comprises at least one compressor downstream of the fan, an overall pressure ratio of the propulsion system being between 40 and 60 inclusive, the overall pressure ratio being defined as a pressure ratio of a total pressure measured upstream of a combustion chamber of the propulsion system to a pressure at the inlet of the fan rotor measured upstream of a root of the fan rotor.

According to an embodiment, the blades of the fan are blades with fixed setting.

According to an embodiment, the aircraft propulsion systems comprises a reduction mechanism rotationally coupling:
the drive shaft and
a fan shaft driving the fan rotor,
   the propulsion system being configured to drive the fan shaft at a rotation speed less than the rotation speed of the drive shaft, a reduction radio of the reduction mechanism being preferably greater than or equal to 2.5 and less than or equal to 11, still preferably greater than or equal to 2.7 and less than or equal to 6.0, still preferably greater than or equal to 2.7 and less than or equal to 3.6, still preferably substantially of 3.0.

According to an embodiment, the diameter of the fan rotor is greater than or equal to 1.270 m and less than or equal to 3.048 m, preferably greater than or equal to 2.159 m and less than or equal to 3.048 m, still preferably substantially equal to 2.286 m.

According to an embodiment, a hub-to-tip ratio of the fan rotor is greater than or equal to 0.22 and less than or equal to 0.32, preferably greater than or equal to 0.235 and less than or equal to 0.30, more preferably less than or equal to 0.27, the hub-to-tip ratio being defined as a ratio Rᵢ/Rₑ, where:
Rᵢ is an inner radius of the fan rotor, measured between the axis X of rotation and a point of intersection between the leading edge of the fan blades and the aerodynamic surface of a fan rotor platform radially delimiting, inside the air flow path at the inlet of the fan rotor;
Rₑ is an outer radius of the fan rotor and is equal to half the fan diameter.

According to an embodiment, the fan rotor comprises at least fourteen blades and at the most twenty-four blades, preferably at least sixteen blades and at the most twenty-four blades, still preferably twenty-two blades.

According to an embodiment, the gas generator comprises a high-pressure spool and a low-pressure spool, the low-pressure spool rotating at a lower rotation speed than the high-pressure spool.

According to an embodiment, the low-pressure spool comprises a low-pressure turbine, the low-pressure turbine having at least three stages and at the most eight stages.

According to an embodiment, the low-pressure spool comprises a low-pressure compressor, the low-pressure compressor having at least two stages and at the most five stages.

According to an embodiment, the high-pressure spool comprises a high-pressure turbine, the high-pressure turbine being two-stage.

According to an embodiment, the high-pressure spool comprises a high-pressure compressor, the high-pressure compressor comprising at least eight and at the most eleven stages.

Provision is also made for an aircraft comprising an aircraft propulsion system as previously defined.

Provision is also made for a method for manufacturing an aircraft propulsion systems, the propulsion system comprising:
a ducted fan section comprising a fan, the fan having a fan rotor comprising blades,
a gas generator comprising a drive shaft configured to rotationally drive, directly or indirectly, the fan rotor,
the manufacturing method comprising a step of dimensioning the fan rotor during which a diameter D of the fan rotor in meters and measured in a plane normal to an axis of rotation of the fan rotor, at an intersection between an end edge and a leading edge of the blades of the fan rotor is chosen such that:

$$a . 0 \leq P \cdot D \cdot {10}^{- 4} \leq 160 and$$

$$b . 2.7 \cdot {( P \cdot D \cdot {10}^{- 4} )}^{0.6} \leq \frac{100 \cdot {D}^{2}}{B P R + 1} \leq 3.9 \cdot {( P \cdot D \cdot {10}^{- 4} )}^{0.6}$$

where P is a maximum thrust generated by the fan in Newtons when the propulsion system is static in takeoff rating, in a standard atmosphere and at sea level;
and BPR is a bypass ratio of the stream crossing the propulsion system, defined as a ratio between a mass flow rate of a secondary air stream flowing through the propulsion system around the gas generator, and of a primary air stream flowing through the gas generator, measured when the propulsion system is static, uninstalled, in a rating corresponding to a takeoff of an aircraft comprising the aircraft propulsion system, in a standard atmosphere and at sea level.

### OVERVIEW OF THE DRAWINGS

Other features, aims and advantages will become further apparent from the following description, which is purely illustrative and non-limiting, and which must be read with reference to the appended drawings, among which:

FIG. 1 schematically represents an aircraft comprising propulsion systems,

FIG. 2 schematically represents, in partial and section view, an example of a propulsion system with a ducted fan section,

FIG. 3 schematically represents a first example of a planetary reduction mechanism,

FIG. 4 schematically represents a first example of an epicyclic reduction mechanism,

FIG. 5 is a graph showing the dimensioning envelope of the aircraft propulsion system in accordance with an embodiment,

FIG. 6 schematically represents a fan section of an aircraft propulsion system.

### DETAILED DESCRIPTION OF AN EMBODIMENT

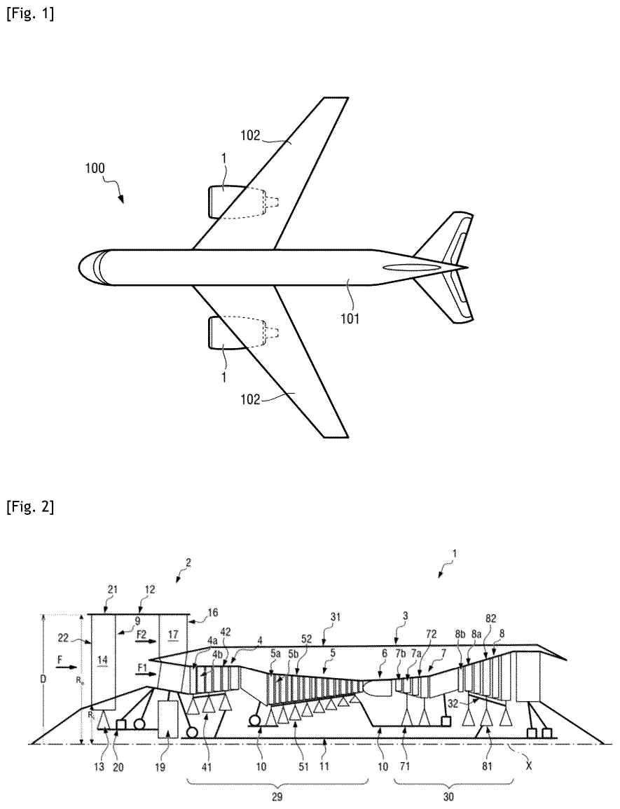

In the example illustrated on FIG. 1, the aircraft 100 is an airplane comprising a fuselage 101 and two wings 102. In this example, the aircraft comprises two propulsion systems 1, each propulsion system 1 being attached to a respective wing 102 of the airplane 100 by way of a pylon. In another embodiment, the aircraft could comprise one or more propulsion systems attached to the fuselage 101.

FIG. 2 schematically represents, in partial and section view, a first example of a propulsion system 1.

In this example, the propulsion system 1 is a gas turbine engine with a twin spool and a ducted fan.

On FIG. 2, the propulsion system 1 has a main direction extending along a longitudinal axis X. The propulsion system 1 comprises a fan section 2 and a primary spool 3, often known as the “gas generator”.

The fan section 2 comprises a fan 22 and a fan casing 12. The fan 22 comprises a fan rotor 9. The fan casing 12 surrounds the fan rotor 9. The fan rotor 9 is mounted rotatably with respect to the fan casing 12.

The fan rotor 9 comprises a fan hub 13 and fan blades 14 extending radially from the hub 13. The fan blades 14 may be fixed with respect to the fan hub 13 or have variable setting. In the latter case (not shown), each of the fan blades 14 is mounted pivotably with respect to the fan hub 13 along a setting axis and is connected to a pitch change mechanism mounted in the propulsion system 1. The pitch change mechanism makes it possible to adjust the setting angle of the fan blades 14 as a function of the flight phases. Such a mechanism is known in principle by those skilled in the art who are familiar with the architectures of aircraft propulsion systems.

The fan rotor 9 comprises at least fourteen fan blades 14 and at the most twenty-four fan blades 14, for example at least sixteen fan blades 14, preferably twenty-two fan blades 14.

In addition, in this example, the fan section 2 also comprises a fan stator 16 mounted fixedly on the fan casing 12. The fan stator 16 comprises fixed blades 17 generally known as Outlet Guide Vanes (OGV). This assembly of fixed blades has the function of straightening and regulating the air stream that flows downstream of the fan rotor 9 to contribute to the thrust of the engine. This assembly of fixed blades also plays a noise-reducing role.

Alternatively, the outlet guide vanes 17 could have variable setting. Where applicable, and similarly to the fan blades 14 of the fan rotor 9, the root of each of the outlet guide vanes 17 is mounted pivotably along a setting axis and is connected to a pitch change mechanism (not shown), the setting being adjusted according to the flight phase by the pitch change mechanism.

The number of outlet guide vanes 17 depends on the acoustic criteria defined for the propulsion system 1 and is at least equal to the number of fan blades 14.

The primary spool 3 comprises a compressor section 29, a combustion chamber 6 and a turbine section 30.

The compressor section 29 comprises a low-pressure compressor 4 and a high-pressure compressor 5.

The low-pressure compressor 4 comprises a rotor 41 suitable for being rotationally driven with respect to the casing 31 of the propulsion system 1 and a stator 42 mounted fixedly on the casing 31.

The rotor 41 of the low-pressure compressor 4 comprises movable wheels 4a and the stator 42 of the low-pressure compressor 4 comprises fixed wheels 4b. The movable wheels 4a are disposed alternately with the fixed wheels 4b, thus forming a series of low-pressure compressor stages.

Similarly, the high-pressure compressor 5 comprises a rotor 51 suitable for being rotationally driven with respect to the casing 31 of the propulsion system 1 and a stator 52 mounted fixedly on the casing 31.

The rotor 51 of the high-pressure compressor 5 comprises movable wheels 5a and the stator 52 of the high-pressure compressor 5 comprises fixed wheels 5b. The movable wheels 5a are disposed alternately with the fixed wheels 5b, thus forming a series of high-pressure compressor stages.

The turbine section 30 comprises a high-pressure turbine 7 and a low-pressure turbine 8.

The high-pressure turbine 7 comprises a rotor 71 suitable for being rotationally driven with respect to the casing 31 of the propulsion system 1 and a stator 72 mounted fixedly on the casing 31.

The rotor 71 of the high-pressure turbine 7 comprises movable wheels 7a and the stator 72 of the high-pressure turbine 7 comprises fixed wheels 7b. The movable wheels 7a are disposed alternately with the fixed wheels 7b, thus forming a series of high-pressure turbine stages.

Similarly, the low-pressure turbine 8 comprises a rotor 81 suitable for being rotationally driven with respect to the casing 31 of the propulsion system 1 and a stator 82 mounted fixedly on the casing 31.

The rotor 81 of the low-pressure turbine 8 comprises movable wheels 8a and the stator 82 of the low-pressure turbine 8 comprises fixed wheels 8b. The movable wheels 8a are disposed alternately with the fixed wheels 8b, thus forming a series of low-pressure turbine stages.

The propulsion system 1 comprises a low-pressure shaft 11 connecting the rotor 81 of the low-pressure turbine 8 to the rotor 41 of the low-pressure compressor 4, the low-pressure shaft 11 being mounted rotatably with respect to the casing 31 about the longitudinal axis X.

When the propulsion system 1 is in operation, the rotor 81 of the low-pressure turbine 8 rotationally drives the rotor 41 of the low-pressure compressor 4 by way of the low-pressure shaft 11.

The propulsion system 1 further comprises a fan shaft 20 and a reduction mechanism 19. The fan rotor 9 is mounted fixedly on the fan shaft 20. The reduction mechanism 19 has an input and an output. The input of the reduction mechanism 19 is connected to the low-pressure shaft 11 and the output of the reduction mechanism 19 is connected to the fan shaft 20. Thus, when the propulsion system 1 is in operation, the rotor 81 of the low-pressure turbine 8 rotationally drives not only the rotor 41 of the low-pressure compressor 4, but also the fan rotor 9, by way of the low-pressure shaft 11, of the reduction mechanism 19 and of the fan shaft 20.

Owing to the reduction mechanism 19, the fan rotor 9 is rotationally driven at a speed less than the rotation speed of the rotor 81 of the low-pressure turbine 8.

The reduction mechanism 19 thus makes it possible to independently control the rotation speed of the fan 22 and the rotation speed of the low-pressure turbine 8 and of the low-pressure compressor 4.

The low-pressure turbine 8, the low-pressure shaft 11, the low-pressure compressor 4, the fan shaft 20, the reduction mechanism 19 and the fan 22 together form the “low-pressure spool” of the propulsion system 1.

The propulsion system 1 further comprises a high-pressure shaft 10 connecting the rotor 71 of the high-pressure turbine 7 to the rotor 51 of the high-pressure compressor 5, the high-pressure shaft 10 being mounted rotatably with respect to the casing 31 about the longitudinal axis X. The high-pressure shaft 10 is coaxial with the low-pressure shaft 11 and extends around the low-pressure shaft 11.

When the propulsion system 1 is in operation, the rotor 71 of the high-pressure turbine 7 rotationally drives the rotor 51 of the low-pressure compressor 5 by way of the low-pressure shaft 10.

The high-pressure turbine 7, the high-pressure shaft 10 and the high-pressure compressor 4 together form the “high-pressure spool” of the propulsion system 1.

The low-pressure shaft 11 and the high-pressure shaft 10 may be corotating, i.e. be driven in the same direction of rotation about the longitudinal axis X. In a variant, the low-pressure shaft 11 and the high-pressure shaft 10 may be contrarotating, i.e. be driven in opposite directions of rotation about the longitudinal axis X.

The twin-spool propulsion system 1 may particularly comprise a single-stage high-pressure turbine 7, i.e. comprising exactly one stage, or a two-stage high-pressure turbine 7, i.e. comprising exactly two stages (as illustrated in the example of FIG. 2).

The high-pressure compressor 5 comprises at least eight stages (as illustrated in the example of FIG. 2) and at the most eleven stages.

The low-pressure turbine 8 comprises at least three stages (as illustrated in the example of FIG. 2) and at the most eight stages.

The low-pressure compressor 4 comprises at least two stages and at the most five stages.

When the propulsion system is in operation, a stream of air F entering the propulsion system 1 traverses the fan 22 then is divided between a primary air stream F1 and a secondary air stream F2, which circulate from upstream to downstream through the propulsion system 1.

The secondary air stream F2, also known as “bypass air stream”, flows through the secondary air path, around the primary spool 3. The secondary air stream F2 makes it possible to cool the periphery of the primary spool 3 and serves to generate most of the thrust supplied by the propulsion system 1.

The primary air stream F1 flows through a primary air path 29 inside the primary spool 3, passing successively through the compressor section 29 (low-pressure compressor 4 and high-pressure compressor 5), the combustion chamber 6 where it is mixed with fuel to serve as comburent, and the turbine section 30 (high-pressure turbine 7 and low-pressure turbine 8). The passage of the primary air stream F1 through the turbine section 30 receiving energy from the combustion chamber 6 causes the rotation of the movable wheels 7a, 8a of the turbine section 30, which in turn rotationally drive the movable wheels 4a, 5a of the compressor section 29 and of the fan rotor 9.

In a propulsion system including a reduction mechanism 19 such as that illustrated on FIG. 2, the uncoupling between the rotation speed of the fan 22 and the rotation speed of the low-pressure turbine 8 makes it possible to reduce the rotation speed and the pressure ratio of the fan rotor 9 while increasing the power extracted by the low-pressure turbine 8. Specifically, the overall efficiency of the propulsion system 1 is first-order conditional on the propulsive efficiency, which is favorably affected by a minimization of the variation in the kinetic energy of the air passing through the propulsion system 1. In a propulsion system with a high bypass ratio, most of the flow rate generating the propulsive force is formed by the secondary air stream F2 of the propulsion system 1, the kinetic energy of the secondary air stream F2 being mostly affected by the compression that is undergone by the secondary air stream F2 during the crossing of the fan section 2. The propulsive efficiency and the pressure ratio of the fan section 2 are therefore related:the lower the pressure ratio of the fan section 2, the better the propulsive efficiency. In order to optimize the propulsive efficiency of the propulsion system 1, the pressure ratio of the fan, which corresponds to the ratio of the average pressure at the outlet of the fan stator 16 (or, in the absence of any stator 16, of the fan rotor 9) to the average pressure at the inlet of the fan rotor 9, is less than or equal to 1.70, preferably less than or equal to 1.50, for example between 0.90 and 1.45. The average pressures are measured here over the height of at least one of the fan blades 14, i.e. the surface that radially delimits, inside, the air flow path at the inlet of the fan rotor 9 at the end edge 21 of the fan blade 14.

The term “end edge” should be understood to mean the edge of the fan blade 14 the furthest from the axis X of rotation of the fan rotor 9 (tip).

The peripheral speed at the end edge 21 of the fan blades 14 can moreover be between 260 meters per second (m·s⁻¹) and 400 meters per second (m·s⁻¹) inclusive. The fan pressure ratio can then be between 1.20 and 1.45.

In a direct-drive propulsion system, the fan rotor 9 can, alternatively, be directly coupled to the low-pressure shaft 11, i.e. without any reduction mechanism. The low-pressure shaft 11 is then colinear with the fan shaft 20 such that the fan rotor 9 is driven by the low-pressure shaft 11 at the same rotation speed as the rotor 81 of the low-pressure turbine 8.

Note that, since FIG. 2 is a partial view, the diameter D is only partially visible in it.

The reduction mechanism 19 may comprise a reduction mechanism, in this example a reduction mechanism with an epicyclic or planetary gear train, single-stage or two-stage.

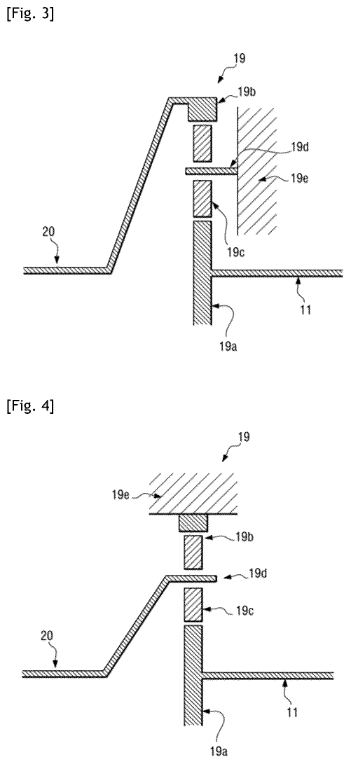

For example, FIG. 3 illustrates a reduction mechanism 19 of star type. The reduction mechanism 19 comprises a sun gear 19a (input of the reduction mechanism 19), centered on an axis of rotation of the reduction mechanism 19 generally colinear with the longitudinal axis X and configured to be rotationally driven by the low-pressure shaft 11, a ring gear 19b (output of the reduction mechanism 19) coaxial with the sun gear 19a and configured to rotationally drive the fan shaft 20 about its axis X of rotation, and a series of satellites 19c circumferentially distributed about the axis X of rotation of the rotor 9 of the fan section 2, between the sun gear 19a and the ring gear 19b, each satellite 19c being meshed internally with the sun gear 19a and externally with the ring gear 19b. The series of satellites 19c is mounted on a planet carrier 19d which is fixed with respect to a stator part 19e of the propulsion system 1, for example with respect to a casing of the compressor section 4, 5.

In another example, FIG. 4 illustrates a reduction mechanism 19 of planetary type, in which case the ring gear 19b is mounted fixedly on the stator part 19e of the propulsion system 1 and the fan shaft 20 is rotationally driven by the planet carrier 19d.

Whatever the configuration of the reduction mechanism 19, the diameter of the ring gear 19b and of the planet-carrier 19d are greater than the diameter of the sun gear 19a, such that the rotation speed of the fan rotor 9 of the fan section 2 is less than the rotation speed of the low-pressure shaft 11.

The reduction ratio of the reduction mechanism 19 is less than or equal to 11, for example greater than or equal to 2.5 and less than or equal to 11, preferably greater than or equal to 2.7 and less than or equal to 6.9, typically around 3.0.

Note that, in this application, and unless otherwise specified, the parameters (pressure, flow rate, thrust, speed etc.) are systematically determined under static conditions, “uninstalled”, i.e. on a test bench and not installed on an aircraft (the measurements then being more simple to take), in takeoff rating in a standard atmosphere and at sea level. Such conditions are for example as described in the manual of the International Civil Aviation Organization (OACI), Doc 7488/3, 3^{rd} edition. It may be considered that any other equivalent standards-related condition which is indicated for the certifications of aircraft propulsion systems such as the standards of the EASA (European Union Aviation Safety Agency), such as its “Certification Specification—Engines” (CS-E) standards or its TCDS “Type Certificate Data Sheets” standards. Another standards text can be the American Certification Regulation 14-CFR. The distances (length, radius, diameter) are on the other hand measured at ambient temperature (approximately 20° C.) when the propulsion system 1 is cool, i.e. when the propulsion system has been shut down for a long enough period for the parts of the propulsion system to be at ambient temperature.

This application makes provision for an aircraft propulsion system dimensioned such as to reduce the fuel consumption necessary for the production of a given thrust. According to its most general embodiment, the propulsion system is dimensioned such as to verify the following pair of relationships:

$$0 \leq P \cdot D \cdot {10}^{- 4} \leq 160 and \qquad 1 )$$

$$2.7 \cdot {( P \cdot D \cdot {10}^{- 4} )}^{0.6} \leq \frac{100 \cdot {D}^{2}}{B P R + 1} \leq 3.9 \cdot {( P \cdot D \cdot {10}^{- 4} )}^{0.6} \qquad 2 )$$

where D represents the diameter of the fan rotor, measured in a plane normal to the axis X of rotation of the fan rotor 9, at the intersection 24 between an end edge 21 and a leading edge 23 of the blades 14 of the fan rotor 9; and P represents a maximum thrust provided by the fan of the propulsion system, expressed in Newton.

For the sake of brevity, in the remainder of the text the expressions X=P.D.10⁻⁴ and

$$Y = \frac{100 \cdot {D}^{2}}{B P R + 1} ,$$

will be defined, such that the inequalities 1 and 2 may be written

$$0 \leq X \leq 160. \qquad 1$$

$$2.7 \cdot {X}^{0.6} \leq Y \leq 3.9 \cdot {X}^{0.6} . \qquad 2.$$

The coefficients 2.7 and 3.9 of the inequality 2 have the same appropriate dimensions for the three terms of the inequality to have the same dimension.

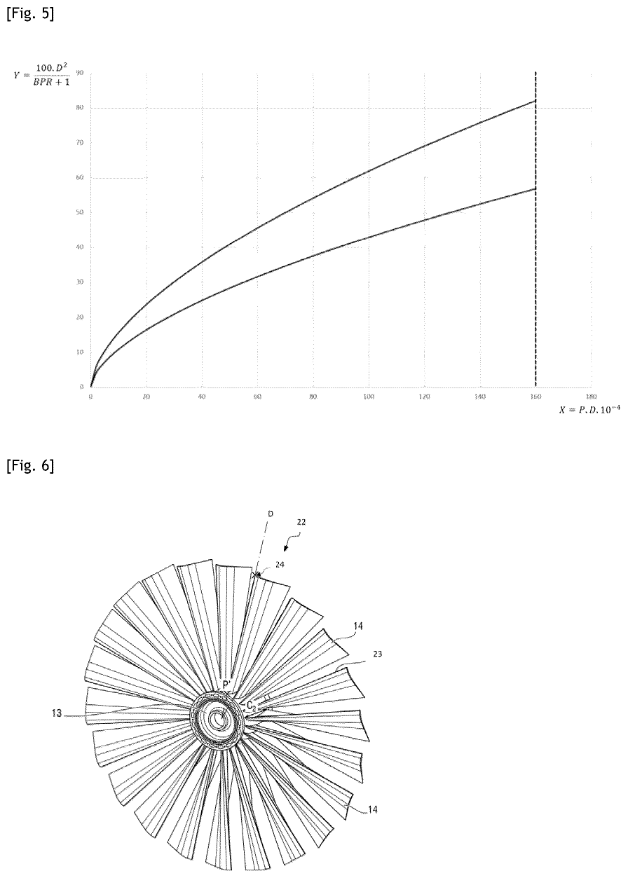

With reference to FIG. 5, a field is thus defined in which the dimensioning of the propulsion system is carried out. When the propulsion system is a twin-spool system, comprising a high-pressure spool and a low-pressure spool, the expression X, which corresponds to the abscissa of FIG. 5, makes it possible to represent a torque supplied by the low-pressure spool. The expression Y, meanwhile, corresponds to the ordinate of FIG. 5 and is an indirect representation of the size of the high-pressure spool viewed from the air which crosses it (so-called “thermodynamic size”). The greater the size of the high-pressure spool, the higher the mass flow rate of air passing through this spool.

Thus, equation 1 defines a maximum value of the torque provided by the low-pressure spool, while equation 2 defines lower and upper bounds of the thermodynamic size of the high-pressure spool for a desired low-pressure shaft torque. The field delimited by these equations corresponds to the area of FIG. 5 contained between two curves and the limit X=160, and has the following advantages:
a significant improvement in the fuel consumption for a given thrust P. Specifically, the inequality 2.7.X^{0.6}≤Y defines an upper dimension limit for the fan rotor, beyond which the fuel consumption becomes too high,
a possibility of industrial exploitation. In other words, the dimensions of the propulsion system and/or the materials that make it possible to verify the equation Y≤3.9.X^{0.6} are realistic.

Below this limit, the high-pressure spool becomes too small, such that marginal losses become too high in relation to the thrust supplied by the high-pressure spool. For example, and purely illustratively, separations between the tips of the high-pressure turbine blades and the casing 31 of the propulsion system cannot be reduced beyond a certain limit. When the high-pressure spool—particularly the high-pressure turbine blades—reaches a critical lower dimension, the size of these separations and the associated energy losses become too significant in relation to the contribution of the high-pressure spool to the thrust.

Furthermore, the reduction in size (or downsizing) of the high-pressure spool requires an increase in the temperature in the combustion chamber 6, and therefore materials capable of withstanding high temperatures. Below a lower limit on the size of the high-pressure spool, no known material is capable of withstanding the corresponding temperature increase.

By comparison with the known aircraft propulsion systems of the prior art, the propulsion system in accordance with this application comprises a high-pressure spool of small size (radially and axially) and a low-pressure spool of large size (in particular radially). One advantage of such a configuration is that it improves the efficiency of the high-pressure spool, i.e. it allows a specific fuel consumption or SFC that is lower for one and the same power supplied by the high-pressure spool.

The propulsion system 1 is configured to supply a maximum thrust of 51,000 lbf (226 859 N), notably between 18,000 lbf (80 068 N) and 51,000 lbf (226 859 N), preferably between 20,000 lbf (88 964 N) and 35,000 lbf (155 688 N).

The diameter D of the ducted fan rotor 9 is preferably less than 3.048 m. The diameter D is preferably between 1.270 m and 3.048 m, more specifically between 2.159 m and 3.048 m, still preferably substantially equal to 2.286 m. This allows the integration of the propulsion system 1 conventionally, in particular under a wing of the aircraft 1. The diameter of the fan rotor 9 is here measured in a plane P1 normal to the longitudinal axis X, which corresponds to the axis of the fan rotor 9, at an intersection 24 between an end edge 21 and a leading edge 23 of the fan blades 14.

To improve the propulsive efficiency of the propulsion system 1 and reduce its specific fuel consumption as well as the noise emitted by the fan section 2, the propulsion system 1 has a high bypass ratio. The term “high” bypass ratio means a bypass ratio greater than or equal to 10, for example between 10 and 80 inclusive, preferably between 10 and 35 inclusive, preferably between 10 and 18 inclusive. The bypass ratio is defined as a ratio of the mass flow rate of the secondary air stream F2 to the mass flow rate of the primary air stream F1. A propulsion system 1 as proposed, having these values of diameter, maximum thrust and bypass ratio, obeys the two inequalities 1 and 2 defined above.

The hub-to-tip ratio corresponds to the ratio of the inner radius Rᵢ to the outer radius Re of the fan rotor 9. The inner radius Rᵢ corresponds to the distance between the axis X of rotation and the point of intersection between the leading edge 23 and the surface that radially delimits, inside, the air flow path 25 at the inlet of the fan rotor 9 (and corresponds to the tie point of the leading edge 23 with the aerodynamic surface of a platform of the fan rotor 9). The outer radius Re corresponds to the distance between the axis X of rotation and the point of intersection 24 between the leading edge 23 and the end edge 21 of the fan blades (and corresponds to half the diameter D of the fan). The lower the hub-to-tip ratio, the better the fan rotor 9 performs. However, the reduction in the hub-to-tip ratio of the fan rotor 9 entails an increase in the mechanical load of the hub 13 of the fan rotor 9. The dimensioning of the fan rotor 9 is such that its hub-to-tip ratio is less than or equal to 0.32. The hub-to-tip ratio is preferably between 0.22 and 0.32 inclusive. This in particular makes it possible to obtain an advantageous thrust via the secondary air stream F2 with respect to the flow rate entering the primary air stream F1.

The overall pressure ratio (or OPR) of the propulsion system is defined as the ratio of the pressure at the outlet of the compressor—or in the case where the propulsion system comprises several compressors, of the compressor located furthest downstream of the flow—and the pressure at the inlet of the fan rotor 9, this latter being measured upstream of the root of the fan rotor 9. The pressure at the outlet of the compressor corresponds to the total pressure upstream of the combustion chamber 6.

Thus, for a twin-spool propulsion system such as that shown on FIG. 2, the overall pressure ratio is the ratio of the pressure at the outlet of the high-pressure compressor 5, which corresponds to the total pressure upstream of the combustion chamber 6, to the pressure at the inlet of the fan rotor 9 measured upstream of the root the fan rotor 9. Advantageously, the overall pressure ratio is less than or equal to 60, preferably between 40 and 60. A high total pressure ratio makes it possible to reduce the specific fuel consumption of the engine, but increases the temperature downstream of the compressors, which may compromise the structural integrity of the materials forming the last stages of the compressor. Moreover, a high total pressure ratio requires several compressor stages and therefore a high total mass of the compressors.

Thus, a total pressure ratio of between 40 and 60 allows a relatively low specific fuel consumption while allowing a moderate temperature downstream of the compressors.

The table below 2 shows a comparative example between a reference propulsion system corresponding to the current technical standard (at the date of filing of this application), that one is seeking to improve, and a propulsion system 1 contained in the dimensioning envelope defined by the inequalities 1 and 2. The standard propulsion system and the propulsion system 1 in accordance with the invention this application are both of twin-spool type and comprise a ducted fan section.

The temperatures at the inlet of the low-pressure turbine rotor (point 6.) are Red Line (or R/L) temperatures, i.e. corresponding to limit values above which the propulsion system in question is not designed to operate under ordinary conditions.

TABLE 1

| | | Propulsion system 1 (in |
|---|---|---|
| | Reference | accordance with the |
| | propulsion | invention the disclosure |
| | system | of this application) |
| 1. Fan diameter D (m) | 2.11 | 2.26 |
| 2. Maximum thrust P (N) | 160 800 | 162 000 |
| 3. Bypass ratio (BPR) | 11 | 15 |
| 4. Overall pressure ratio | 42 | 55 |
| (OPR) | | |
| 5. Temperature at the | 1850 | 1950 |
| inlet of the high-pressure | | |
| turbine rotor (K) | | |
| 6. Temperature at the | 1300 | 1365 |
| inlet of the low-pressure | | |
| turbine rotor (K) | | |
| 7. Hub-to-tip ratio of the | 0.3 | 0.3 |
| fan rotor | | |
| 8. Pressure ratio of the | 1.43 | 1.35 |
| fan | | |
| 9. Number of stages of the | 2 | 3 |
| low-pressure compressor | | |
| 10. Number of stages of | 10 | 10 |
| the high-pressure | | |
| compressor | | |
| 11. Number of stages of | 2 | 2 |
| the high-pressure turbine | | |
| 12. Number of stages of | 4 | 4 |
| the low-pressure turbine | | |
| 13. Y = 100.D²/(BPR + 1) | 37.10 | 31.92 |
| 14. X = P.D.10⁻⁴ | 33.93 | 36.62 |

To go from the reference propulsion system 1 to the propulsion system 1 in accordance with this application, the BPR has been increased, allowing a gain in specific fuel consumption. The fan diameter D has been increased to make it possible to conserve a maximum thrust close to the maximum thrust of the reference engine. The overall pressure ratio (OPR) has also been increased, as well as the temperature at the inlet of the high-pressure turbine rotor, thus making it possible to improve the thermal efficiency of the propulsion system 1. This increase in the temperature obtained for the propulsion system 1 in accordance with this application, at points 5, and 6. of table 2, is made possible owing to the use of turbine discs, the manufacturing of which involves powder metallurgy, and owing to a first low-pressure turbine stage comprising blades made of ceramic matrix composite material.

An improvement in the thermal propulsion efficiency of approximately 10% is observed for the propulsion system 1 in accordance with this application by comparison with the reference propulsion system.

1. An aeronautical propulsion system; comprising:
a ducted fan section comprising a fan, the fan having a fan rotor comprising blades, and
a gas generator comprising a drive shaft configured to rotationally drive, directly or indirectly, the fan rotor,
wherein the aeronautical propulsion system is dimensioned such as to verify the following pair of relationships:
$$a . 0 \leq P \cdot D \cdot {10}^{- 4} \leq 160 and$$
$$b . 2.7 \cdot {( P \cdot D \cdot {10}^{- 4} )}^{0.6} \leq \frac{100 \cdot {D}^{2}}{B P R + 1} \leq 3.9 \cdot {( P \cdot D \cdot {10}^{- 4} )}^{0.6}$$
where:
D is a diameter of the fan rotor in meters which is measured in a plane normal to an axis of rotation of the fan rotor, at an intersection between an end edge and a leading edge of the blades of the fan rotor;
P is a maximum thrust generated by the fan in Newtons when the aeronautical propulsion system is static at takeoff regime, in a standard atmosphere and at sea level; and
BPR is a bypass ratio of a flow through the aeronautical propulsion system, defined as a ratio between a mass flow rate of a secondary air stream flowing through the aeronautical propulsion system around the gas generator, and of a primary air stream flowing through the gas generator, measured when the aeronautical propulsion system is static, uninstalled, at a regime corresponding to a takeoff of an aircraft comprising the aircraft propulsion system, in a standard atmosphere and at sea level.

2. The aeronautical propulsion system of claim 1, wherein the bypass ratio is between 10 and 20 inclusive.

3. The aeronautical propulsion system of claim 1, wherein the gas generator comprises at least one compressor downstream of the fan, an overall pressure ratio of the aeronautical propulsion system being between 40 and 60 inclusive, and
the overall pressure ratio is defined as a pressure ratio of a total pressure measured upstream of a combustion chamber of the aeronautical propulsion system to a pressure at an inlet of the fan rotor measured upstream of a root of the fan rotor.

4. The aeronautical propulsion system of claim 1, wherein the blades of the fan are blades with fixed pitch.

5. The aeronautical propulsion system of claim 1, further comprising a reduction structure rotationally coupling:
the drive shaft, and
a fan shaft driving the fan rotor,
wherein the aeronautical propulsion system is configured to drive the fan shaft at a rotation speed less than a rotation speed of the drive shaft, a reduction radio of the reduction structure being greater than or equal to 2.5 and less than or equal to 11.

6. The aeronautical propulsion system of claim 1, wherein a diameter of the fan rotor is greater than or equal to 1.270 m and less than or equal to 3.048 m.

7. The aeronautical propulsion system of claim 1, wherein a hub-to-tip ratio of the fan rotor is greater than or equal to 0.22 and less than or equal to 0.32,
the hub-to-tip ratio being defined as a ratio Rᵢ/Rₑ,
where:
Rᵢ is an inner radius of the fan rotor, measured between an axis of rotation and a point of intersection between the leading edge of the fan blades and an aerodynamic surface of a fan rotor platform radially delimiting, inside, an air flow path at the inlet of the fan rotor;
Rₑ is an outer radius of the fan rotor and is equal to half the fan diameter.

8. The aeronautical propulsion system of claim 1, wherein the fan rotor comprises at least fourteen blades and at the most twenty-four blades.

9. The aeronautical propulsion system as claimed of claim 1, wherein the gas generator comprises a high-pressure spool and a low-pressure spool, the low-pressure spool rotating at a lower rotation speed than a rotation speed of the high-pressure spool.

10. The aeronautical propulsion system of claim 9, wherein the low-pressure spool comprises a low-pressure turbine, the low-pressure turbine having at least three stages and at the most eight stages.

11. The aeronautical propulsion system of claim 9, wherein the low-pressure spool comprises a low-pressure compressor, the low-pressure compressor having at least two stages and at the most five stages.

12. The aeronautical propulsion system of claim 9, wherein the high-pressure spool comprises a high-pressure turbine, the high-pressure turbine being a two-stage turbine.

13. The aeronautical propulsion system of claim 9, wherein the high-pressure spool comprises a high-pressure compressor, the high-pressure compressor comprising at least eight and at the most eleven stages.

14. An aircraft comprising the aeronautical propulsion system of claim 1, wherein the aeronautical propulsion system is attached to a wing of the aircraft.

15. A method for manufacturing an aircraft propulsion system, the aircraft propulsion system comprising:
a ducted fan section comprising a fan, the fan having a fan rotor comprising blades, and
a gas generator comprising a drive shaft configured to rotationally drive, directly or indirectly, the fan rotor,
the manufacturing method comprising:
dimensioning the fan rotor during which a diameter D of the fan rotor in meters and measured in a plane normal to an axis of rotation of the fan rotor, at an intersection between an end edge and a leading edge of the blades of the fan rotor is chosen such that:
$$0 \leq P \cdot D \cdot {10}^{- 4} \leq 160 and$$
$$2.7 \cdot {( P \cdot D \cdot {10}^{- 4} )}^{0.6} \leq \frac{100 \cdot {D}^{2}}{B P R + 1} \leq 3.9 \cdot {( P \cdot D \cdot {10}^{- 4} )}^{0.6}$$
where:
P is a maximum thrust generated by the fan in Newtons when the aircraft propulsion system is static in takeoff regime, in a standard atmosphere and at sea level; and
BPR is a bypass ratio of a stream crossing the aircraft propulsion system, defined as a ratio between a mass flow rate of a secondary air stream flowing through the aircraft propulsion system around the gas generator, and of a primary air stream flowing through the gas generator, measured when the aircraft propulsion system is static, uninstalled, at a regime corresponding to takeoff of an aircraft comprising the aircraft propulsion system, in a standard atmosphere and at sea level.

16. The aeronautical propulsion system of claim 5, wherein the reduction radio of the reduction structure is greater than or equal to 2.7 and less than or equal to 6.0.

17. The aeronautical propulsion system of claim 6, wherein the diameter of the fan rotor is greater than or equal to 2.159 m and less than or equal to 3.048 m.

18. The aeronautical propulsion system of claim 7, wherein the hub-to-tip ratio of the fan rotor is greater than or equal to 0.235 and less than or equal to 0.30.

19. The aeronautical propulsion system of claim 8, wherein the fan rotor comprises at least sixteen blades and at the most twenty-four blades.
